(19) United States
(12) Patent Application Publication
(10) Pub. No.: US 2013/0038629 A1
(43) Pub. Date: Feb. 14, 2013

(54) METHOD AND DEVICE FOR VISUALIZING THE REGISTRATION QUALITY OF MEDICAL IMAGE DATASETS

(71) Applicants: Stefan Lautenschläger, Hausen (DE); Martin Trini, Furth (DE)

(72) Inventors: Stefan Lautenschläger, Hausen (DE); Martin Trini, Furth (DE)

(21) Appl. No.: 13/584,097

(22) Filed: Aug. 13, 2012

(30) Foreign Application Priority Data
Aug. 12, 2011 (DE) 102011080905.8

(51) Int. Cl. G09G 5/00

(52) U.S. Cl. 345/629

(57) ABSTRACT

A method for visualizing a registration quality of medical image datasets is provided. A reference image and an object image are acquired and registered with each other to form a merged image by a registration method having a non-elastic and an elastic registration method section. A deformation field is determined having displacement vectors from image points of the object image to image points of the reference image which are conditioned by the elastic registration method section. One region of the merged image is overlayed with an overlay into which parameters of the deformation field are fed. The region of the merged image and the overlaid overlay is visualized.

### CROSS REFERENCE TO RELATED APPLICATIONS

This application claims priority of German application No. 10 2011 080 905.8 filed Aug. 12, 2011, which is incorporated by reference herein in its entirety.

### FIELD OF INVENTION

The present application relates to a method for visualizing the registration quality of medical image datasets. Additionally the present application relates to a corresponding device for visualizing the registration quality of medical image datasets.

### BACKGROUND OF INVENTION

In interventional radiology, in the evaluation of a case, image datasets of different modalities, such as for example 2D and 3D x-ray recordings (XA), computed tomography (CT), magnetic resonance tomography (MR), positron emission tomography (PET), single-photon emission computed tomography (SPECT) or sonography (US), are often displayed merged, i.e. overlaid. In this way a physician can combine the respective advantages of the various methods for a specific case. Ideally only elementary digital image processing operations, such as rotations or displacements, are necessary to overlay two images, in order to bring the images correctly into congruence. This is known as rigid registration of two recordings or image datasets. In practice the recordings to be overlaid are often made at different times or with different camera positions and hence may display displaceable or flexible objects, such as blood vessels, organs or muscles, in a different position or shape. For example, respiratory artifacts or different arm positions during two recordings may be the reason why a blood vessel or an organ, e.g. the liver, assumes a different position in a first image than in a second image. Rigid registration would in this case provide an unsatisfactory overlay quality. In such cases a non-rigid, flexible or elastic registration is often used, which transfers objects in an image to the corresponding objects in a different image. When using a non-rigid registration algorithm the fact that it is difficult for someone examining the registration result, i.e. the merged image, to evaluate which part of an image has been more intensely and which less intensely “elastically” transformed can be problematic. If for example a region of an image which is important for a diagnosis is intensely changed by a non-rigid registration algorithm, this may result in an incorrect evaluation with far-reaching consequences.

### SUMMARY OF INVENTION

The object of the present application is thus to specify a method for visualizing the registration quality of medical image datasets.

The application achieves this object with a method for visualizing the registration quality of medical image datasets with the features of the first independent claim and a device for visualizing the registration quality of medical image datasets with the features of the second independent claim.

The basic idea underlying the application is a method for visualizing a registration quality of medical image datasets, which comprises the following method steps:
S1) acquisition of a reference image and an object image;
S2) registration of the reference image with the object image to form a merged image with the aid of a registration method, which comprises a non-elastic and an elastic registration method section;
S3) determination of a deformation field, wherein the deformation field comprises displacement vectors from image points of the object image to image points of the reference image, which are conditioned by the elastic registration method section;
S4) overlaying at least one region of the merged image with an overlay, into which parameters of the deformation field are fed;
S5) visualization of the at least one region of the merged image and of the overlaid overlay.

In the first method step a reference image and an object image are acquired. For this purpose an imaging method referred to in the introduction can be used. Both images can be obtained using the same or different imaging methods. The images may be spatial, i.e. three-dimensional, images, two-dimensional images or two-dimensional sectional images of a 3D image dataset. Image and image dataset are used as synonyms below. In the case of a spatial image the image points are referred to as voxels, and in two dimensions as pixels. The reference image and the object image generally comprise different image sections of an examination object, e.g. of a person or an animal, but the intersecting set is not empty.

In the second method step the reference image is registered with the object image with the aid of a registration method to form a merged image. Image registration of two images refers to a method in digital image processing, with the aid of which two images of an at least similar scene are made to match one another as closely as possible. The reference image is not changed. For the object image a transformation is determined which adjusts the object image as closely as possible to the reference image. What is involved here is thus a problem of optimization. Image registration is a common task in medical image processing for which there are numerous proposed solutions. Examples of usable optimization methods for registration methods that can be cited are gradient descent methods, downhill simplex methods, hillclimb methods and simulated annealing. In general non-elastic and elastic registration methods can be distinguished. A non-elastic registration method means an image registration method in which rigid transformations such as translation and rotation, affine transformations such as scaling and shearing, and projective transformations can be used. An elastic registration method means an image registration method in which elastic transformations (also called “non-rigid transformations”) such as spline-based or polynomial-based transformations, can be applied. The disclosed second method step uses a registration method which comprises a non-elastic and an elastic registration method section. This means that rigid, affine and projective transformations, where these are applied in the registration method, can be assigned to the non-elastic registration method section. It is also conceivable that displacement, rotation and size adjustment are performed by an operator. Elastic transformations can be assigned to the elastic registration method section. Instead of one registration method containing a non-elastic and an elastic registration method section a non-elastic registration method and subsequently an elastic registration method can be applied.

In the third method step a deformation field is determined, wherein the deformation field comprises displacement vectors from image points of the object image to image points of the reference image which are conditioned by the elastic registration method section. The deformation field can be a matrix of vectors which relocates each image point of the object image such that optimum conformity with the reference image is achieved.

In the fourth method step at least one region of the merged image is overlaid with an overlay, into which parameters of the deformation field are fed. Parameters, e.g. distance dimensions or derivations which determine the overlay or the elements thereof, are thus calculated from the deformation field. The overlay is then overlaid coincidently over a region of the merged image or the whole merged image.

In the fifth and last method step the at least one region of the merged image and the overlaid overlay are visualized. Visualization of the at least one region of the merged image can refer to the display of the region of the merged image e.g. on a monitor. The overlay, the elements of which, as described, are determined by parameters, such as distance dimensions, of the deformation field, is graphically overlaid over this region of the merged image.

The overlay comprises a matrix, the elements of which are determined from the Jacobi matrix of the deformation field. The derivations or gradients of the deformation field are thus fed into the overlay, so that the elements of the overlay are a measure of the intensity of the adjustment or of the deformation of objects of the object image to the reference image.

In another embodiment the overlay comprises a matrix, the elements of which are determined from the length of assignment vectors which describe the assignment of the image points of the reference image from the image points of the object image. The displacement vectors from the deformation field and the length parameter of the displacement vectors from the deformation field are fed into the overlay. The lengths or the absolute values of the assignment vectors are a measure of the intensity of the adjustment or of the deformation of objects of the object image to the reference image.

An embodiment of the application provides that the visualization of the at least one region of the merged image and of the overlaid overlay comprises a color coding of the elements of the overlay, wherein predefinable value ranges are assigned to a predefinable color palette or wherein the value range of the elements of the overlay is assigned to a predefinable color palette. Assuming an overlay matrix, the elements of which indicate to what extent the image points of the object image have been displaced by the elastic registration method section, in order to bring them into conformity with the corresponding image points of the reference image, a display of the intensity of the deformation which is intuitively understandable for a human observer is enabled thanks to color coding. Known color schemes are used, such as transparency for no deformation, green for a slight deformation, through yellow to red for a large deformation. The assignment of the degree of deformation and color can be predefined by a user. In this case the assignment can be predefined absolutely or a predefinable color palette extends in each case across the value range of the overlay, i.e. for example a deformation intensity of 0 to 10% of the maximum intensity of deformation is assigned no color or transparency, 10% to 20% the color green, etc., up to the color red for 90% to 100% of the maximum intensity of deformation.

In another embodiment at least one region of interest in the reference image can be predefined, by an operator, which in accordance with the non-elastic registration method section of the registration method of reference image and object image is taken into account by the elastic registration method section of the registration method. In diagnostics it can be advantageous if only one region of interest (ROI) is taken into account by the elastic registration method section of the registration method. The method step is thus represented as follows: one or more regions of interest are marked in the reference image, e.g. by an operator. A non-elastic registration of reference image and object image is followed by an elastic registration, which is however limited to the region or regions of interest. The overlay and the visualization thereof with the merged image consequently comprise only the regions of interest. This embodiment can be referred to as a punching operation, as the regions of interest are as it were “punched” out of the reference image and only these undergo elastic registration.

It is conceivable for the reference image and the object image to comprise 3D image datasets and for the registered image to be visualized as a 2D sectional image with the overlaid overlay.

Another basic idea underlying the application relates to a device for visualizing the registration quality of medical image datasets. The device comprises a reception means for receiving an acquired reference image and an acquired object image. The device further comprises at least one calculation means for registering the reference image with the object image to form a merged image with the aid of a registration method, which comprises a non-elastic and an elastic registration method section, and for determining a deformation field, wherein the deformation field comprises displacement vectors from image points of the object image to image points of the reference image, which are conditioned by the elastic registration method section, and for overlaying at least one region of the merged image with an overlay, into which parameters of the deformation field are fed. The device further comprises a display means for visualizing the at least one region of the merged image and of the overlaid overlay.

An embodiment of the application provides for the calculation means and the display means of the device to be designed to execute a previously described method.

Advantages which may be achieved from using one of the disclosed methods or one of the disclosed devices may be:
an increase in the quality of a diagnosis, as intensely deformed regions are specifically characterized;
a time saving for a physician, as “critical” regions are automatically marked, conspicuously in color;
a simple implementation of the calculation and patient-specific dose application;
a plausibility check on elastic registration for a physician, as for example it is not expected of bones that they are deformed.

### BRIEF DESCRIPTION OF THE DRAWINGS

The embodiments depicted below represent embodiments of the present application. Other developments emerge from the following figures plus description, in which:

FIG. 1 shows a flowchart of a disclosed method for visualizing a registration quality of medical image datasets;

FIG. 2 schematically shows an embodiment of a registration of two medical images according to the prior art;

FIG. 3 schematically shows an embodiment of a registration of two medical images and a disclosed visualization of the registration quality;

FIG. 4 schematically shows displacement vectors from object image points to reference image points;

FIG. 5 schematically shows an embodiment of a visualization of an overlay;

FIG. 6 schematically shows a device for visualizing the registration quality of medical image datasets.

### DETAILED DESCRIPTION OF INVENTION

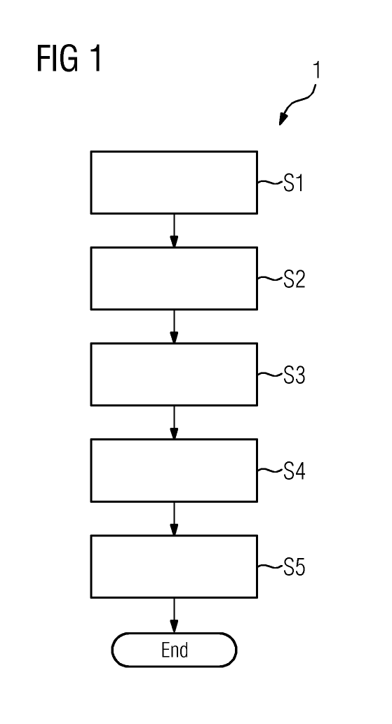

FIG. 1 shows a flowchart of one disclosed method for visualizing the registration quality of medical image datasets. The method comprises five method steps S1 to S5 and ends (“End”) after method step S5. Individually the following method steps are executed:
S1) acquisition of a reference image and an object image;
S2) registration of the reference image with the object image to form a merged image with the aid of a registration method, which comprises a non-elastic and an elastic registration method section;
S3) determination of a deformation field, wherein the deformation field comprises displacement vectors from image points of the object image to image points of the reference image, which are conditioned by the elastic registration method section;
S4) overlaying at least one region of the merged image with an overlay, into which parameters of the deformation field are fed;
S5) visualization of the at least one region of the merged image and of the overlaid overlay.

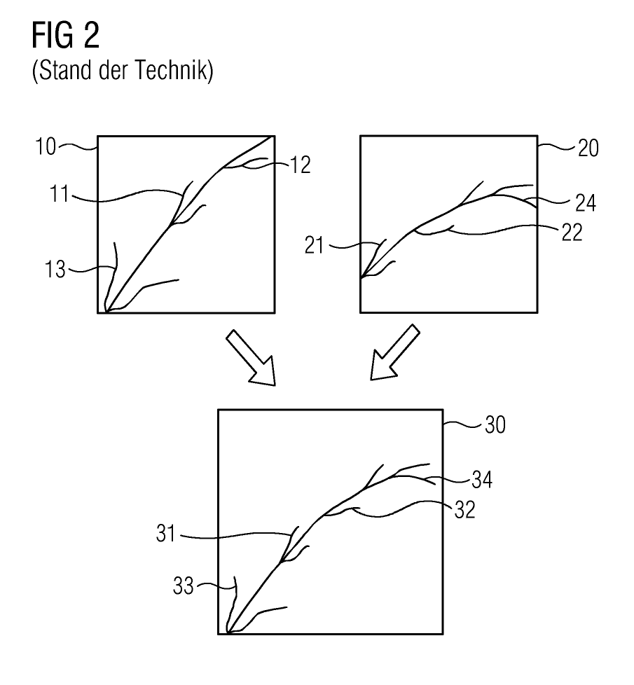

FIG. 2 schematically shows an embodiment of a registration of two medical images 10 and 20 according to the prior art. The reference image 10 has been obtained for example with an x-ray device using digital subtraction angiography (DSA) and shows part of a blood vessel. A lower part 13, a central part 11 and an upper part 12 can be identified. The object image 20 shows the same blood vessel, but has however been recorded e.g. at a later point in time and initially differs most obviously from the reference image 10 by a different image section and changed geometric projection settings during the recording. The blood vessel is rotated clockwise overall. The lower part 21 of the blood vessel corresponds to the central part 11 of the reference image, while the upper part 24 is outside the image section of the reference image. It is not immediately obvious that the vessel sections 12 and 22 differ, although they must be the same in terms of position. The reason could for example be that the patient moved slightly between the two recordings. After applying a registration method according to the prior art a merged image 30 is obtained. The parts 31, 32 and 33 of this resemble the reference image 10, with the corresponding parts 11, 12 and 13. The merged image 30 is expanded by the image section 34, which originates from the part 24 of the object image 20. For this purpose the non-elastic registration method section of the registration method used has rotated the object image 20 and displaced its position such that the image sections, which are contained both in the reference image and in the object image, overlay one another as congruently as possible. A problem is posed by the image section 32, which should have arisen from the overlaying of the different image sections 12 and 22. In this example, in the event of a discrepancy between two images the display of the reference image is used by an elastic registration method, i.e. the image points of the object image are mapped to the image points of the reference image. Another possibility would for example be to use a mean value of both images. Ultimately it is not possible for someone looking at the merged image to tell which parts of the merged image can be regarded as reliable, as they are the same in both representations, and which ones may have been falsified. This can result in incorrect interpretations e.g. during a diagnosis.

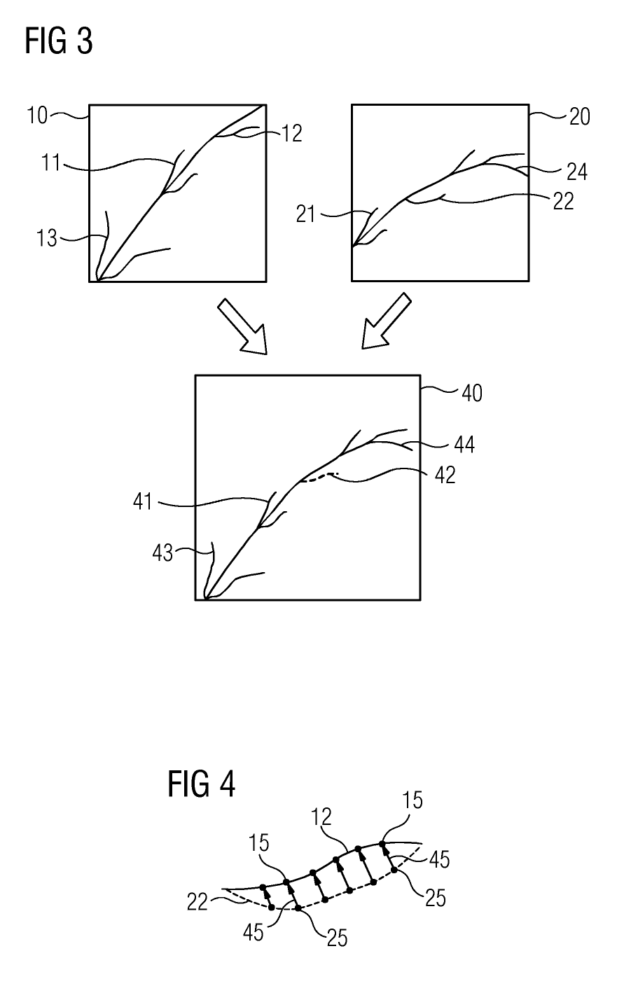

FIG. 3 schematically shows an embodiment of a registration of the two medical images 10 and 20, and a disclosed visualization of the registration quality. The situation is analogous to the example described in FIG. 2. The starting point is the reference image 10 and the object image 20, which are combined with one another in order for example to obtain a larger image section. For this purpose the reference image 10 is registered with the object image 20 to form a merged image 40. A registration method is used for this, and comprises a non-elastic registration method section which rotates and displaces the object image for example, and the result of which is the image sections 41, 43 and 44 of the merged image 40. An elastic registration method section of the registration method used deforms objects of the object image such that they are as congruent as possible with corresponding objects of the reference image. Registration methods that can be used here are known from the prior art. A deformation field is now determined. The deformation field comprises displacement vectors from the image points of the object image to the corresponding image points of the reference image. Furthermore, an overlay is overlaid over the merged image. The overlay is for example a matrix, the elements of which are determined from the length of assignment vectors which describe the assignment of the image points of the reference image from the image points of the object image. The displacement vectors from the deformation field and the length parameter of the displacement vectors from the deformation field are thus fed into the overlay. The lengths or the absolute values of the assignment vectors are a measure of the intensity of the adjustment or deformation of objects of the object image to the reference image. Finally the merged image and the overlaid overlay are visualized, i.e. the overlay is overlaid over the merged image and both are displayed. The result is shown schematically in the merged image 40. The image section 42 is made readily identifiable by the overlaid overlay. For someone looking at the merged image it is easy to see that the image section 42 has been deformed and consequently in this region the registration quality is poorer than in other parts of the image.

FIG. 4 schematically shows displacement vectors 45 from object image points 25 to reference image points 15. The elastic registration method displaces the image points 25 which describe the curve 22 of the object image to the image points 15 which describe the curve 12 of the reference image. These displacement vectors 45 are fed into the deformation field.

FIG. 5 schematically shows an embodiment of a visualization of an overlay 50. The lengths of the displacement vectors from the deformation field are for example fed into the overlay 50, i.e. the further an image point has been displaced from the object image, in order to meet the corresponding image point from the reference image, the longer the corresponding vector in the deformation field and the larger the corresponding value in the overlay. The values of the elements of the overlay are color-coded for the visualization. This means that a predefinable value range is assigned to a predefinable color palette. Thus for example small values, i.e. slight displacements, are characterized by green, while large values are characterized by a conspicuous red. In the overlay 50 this situation is represented by a continuous line 55, which characterizes a large displacement or deformation, the dotted line 56 characterizing a lesser deformation.

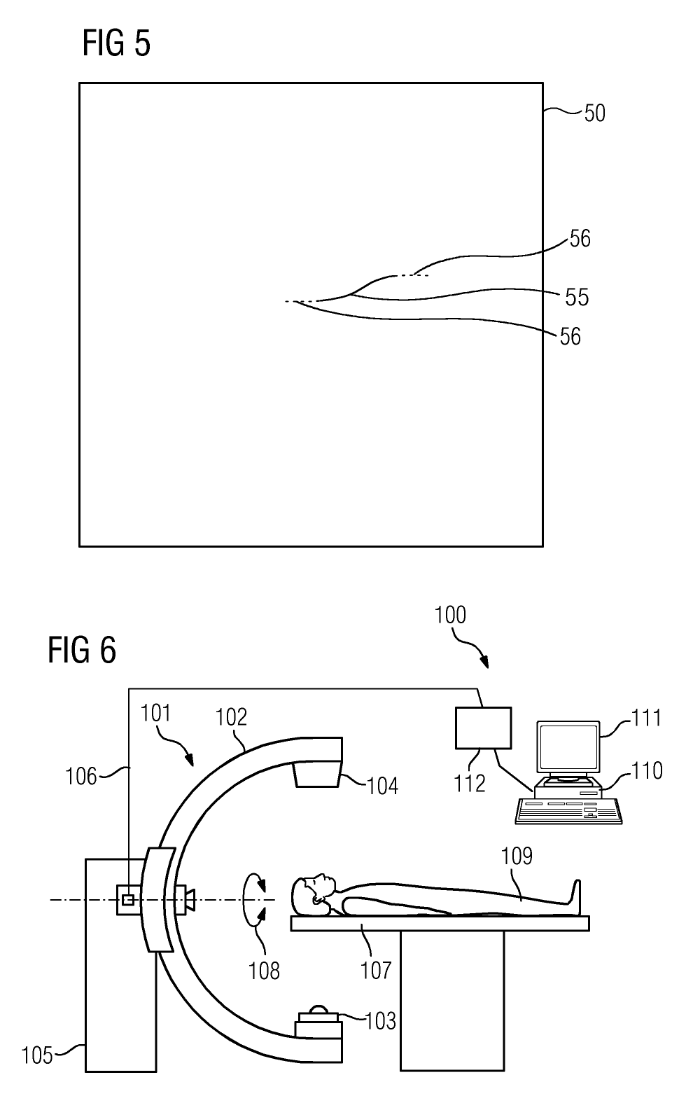

Finally, FIG. 6 schematically represents an embodiment of a device 100 for visualizing the registration quality of medical image datasets. The device 100 comprises a reception means 112, e.g. an electronic interface card, for receiving an acquired reference image and an acquired object image. For this purpose the reception means 112 is connected to a C-arm x-ray device 101 via an electrical connection means 106, e.g. an electrical line bus. The C-arm x-ray device 101 comprises a C-arm 102, which is disposed on a stand 105 and on which are disposed opposite one another an x-ray source 103 and an x-ray detector 104. The C-arm x-ray device 101 is designed, by rotation 108 of the C-arm 102, to take several x-ray images from different recording positions and from this to create a 3D image dataset. A patient 109, e.g. a person, is lying on a patient couch 107. The device 100 further comprises a calculation means 110, e.g. a computer, for registering the reference image with the object image to form a merged image with the aid of a registration method, which comprises a non- elastic and an elastic registration method section, and for determining a deformation field, wherein the deformation field comprises displacement vectors from image points of the object image to image points of the reference image, which are conditioned by the elastic registration method section, and for overlaying at least one region of the merged image with an overlay, into which parameters of the deformation field are fed. The device 100 further comprises a display means 111, e.g. a monitor, for visualizing the at least one region of the merged image and of the overlaid overlay.

1. A method for visualizing a registration quality of medical image datasets, comprising:
acquiring a reference image and an object image;
registering the reference image with the object image to form a merged image by a registration method, wherein the registration method comprises a non-elastic and an elastic registration method section;
determining a deformation field comprising displacement vectors from image points of the object image to image points of the reference image, wherein the displacement vectors are conditioned by the elastic registration method section;
overlaying at least one region of the merged image with an overlay into which parameters of the deformation field are fed; and
visualizing the at least one region of the merged image and of the overlaid overlay.

2. The method as claimed in claim 1, wherein the overlay comprises a matrix, and wherein elements of the matrix are determined from Jacobi matrix of the deformation field.

3. The method as claimed in claim 1, wherein the overlay comprises a matrix, and wherein elements of the matrix are determined from length of assignment vectors describing assignment of the image points of the reference image from the image points of the object image.

4. The method as claimed in claim 1, wherein the visualization of the at least one region of the merged image and of the overlaid overlay comprises a color coding of elements of the overlay.

5. The method as claimed in claim 4, wherein the color coding comprises predefinable value ranges assigned to a predefinable color palette.

6. The method as claimed in claim 4, wherein a value range of the elements of the overlay is assigned to a predefinable color palette.

7. The method as claimed in claim 1, wherein at least one region of interest is predefined in the reference image and is taken into account by the elastic registration method section after the non-elastic registration method section of the reference image and the object image.

8. The method as claimed in claim 1, wherein the reference image and the object image comprise 3D image datasets and the registered image is visualized as a 2D sectional image with the overlaid overlay.

9. A device for visualizing a registration quality of medical image datasets, comprising:
a reception device for receiving an acquired reference image and an acquired object image;
a calculation device for:
registering the reference image with the object image to form a merged image by a registration method, wherein the registration method comprises a non-elastic and an elastic registration method section,
determining a deformation field comprising displacement vectors from image points of the object image to image points of the reference image, wherein the displacement vectors are conditioned by the elastic registration method section, and
overlaying at least one region of the merged image with an overlay into which parameters of the deformation field are fed; and
a display device for visualizing the at least one region of the merged image and of the overlay.
